(19) United States
(12) Patent Application Publication
(10) Pub. No.: US 2025/0305480 A1
(43) Pub. Date: Oct. 2, 2025

(54) KITE LAUNCHING AND LANDING GUIDE DEVICE

(71) Applicant: TOYOTA JIDOSHA KABUSHIKI KAISHA, Toyota-shi (JP)

(72) Inventors: Tateru FUKAGAWA, Fujisawa-shi (JP); Hayato MASUKI, Fuji-shi (JP); Yoshiharu SAITO, Gotemba-shi (JP); Mikikane HIROHATA, Sunto-gun (JP); Tetsuyuki OE, Koganei-shi (JP)

(73) Assignee: TOYOTA JIDOSHA KABUSHIKI KAISHA, Toyota-shi (JP)

(21) Appl. No.: 19/064,159

(22) Filed: Feb. 26, 2025

(30) Foreign Application Priority Data
Mar. 28, 2024 (JP) 2024-054885

(51) Int. Cl. F03D 5/00

(52) U.S. Cl. CPC F03D 5/015; F05B 2240/9172; F05B 2240/921

(57) ABSTRACT

A launching and landing guide device is arranged in a floating side unit having a winch and a sail for unwinding and winding the tether. The launching and landing guide device includes a position setting unit that sets a position at which the tether is unwound or unwound, and a launching and landing guide unit that is capable of fixing the kite when the tether is wound and guides the kite and the tether when the tether is unwound or unwound.

### CROSS-REFERENCE TO RELATED APPLICATION

This application claims priority to Japanese Patent Application No. 2024-054885 filed on Mar. 28, 2024, incorporated herein by reference in its entirety.

### BACKGROUND

### 1. Technical Field

The present disclosure relates to launching and landing guide devices that are provided in a floating unit and that guide a kite or a tether so as to allow smooth landing or recovery, storage or fixing, or launching of the kite. The floating unit is a floating unit, such as a yacht, constituting various systems that fly a kite from the floating unit, such as a tethered wind power generation system, an observation system, a transportation system, and a communication system.

### 2. Description of Related Art

Various types of vessels with sails that fly a kite from their sterns have been proposed as this type of floating unit or an offshore unit (see Japanese Unexamined Patent Application Publication No. 2018-151113 (JP 2018-151113 A)). According to these techniques, the vessels are designed to fly a kite from aft of the sails in an aft direction and thus to launch and land the kite in the same manner as in the case of flying a kite on land.

### SUMMARY

However, the above related art is technically disadvantageous for the following reason. For example, when it is desired to temporarily retract a kite or land a kite in an emergency in the event of a strong or stormy wind, it is extremely difficult to land the kite or launch and land the kite while controlling its position or trajectory and its attitude in air so that the kite or tether flapping in the wind does not get entangled with or hit the sails etc.

An object of the present disclosure is to provide a kite launching and landing guide device that is provided in a floating unit, such as a yacht, constituting, for example, systems using various types of kites, and that guides a kite or a tether so as to allow smooth landing or recovery, storage or fixing, or launching of the kite.

In order to solve the above issue, one aspect of a kite launching and landing guide device according to the present disclosure is a kite launching and landing guide device that is disposed in a floating unit including a winch and a sail. The winch is configured to unwind and wind a tether with a kite attached to the tether. The kite launching and landing guide device includes: a position setting unit configured to set a position where the tether is unwound and wound to a position where the tether and the kite do not interfere with at least the sail of the floating unit; and a launching and landing guide unit including a contact portion. The launching and landing guide unit is configured to, when the tether is wound by the winch, fix the kite by contacting the kite at the contact portion by a tension received from the winch via the tether. The launching and landing guide unit is configured to, when the tether is unwound or wound via the position setting unit, guide the kite and the tether in such a manner that the tether passes through a space beside the contact portion or between the contact portions.

With the kite launching and landing guide device of the above aspect of the present disclosure, the tether or the kite neither gets tangled with nor hits the sails even when the tether is wound at a high speed by the winch at the time of landing the kite. After the kite is landed, the kite is fixed on the floating unit as the kite is in contact with the contact portion with the tether taut. The subsequent launching of the kite can also be performed relatively easily because the launching can be started with the kite being in a predetermined attitude, namely an attitude in which the kite is fixed to the kite launching and landing guide device.

Such functions and effects of the present disclosure will become more apparent from the embodiments of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view showing an entire configuration of a kite launching and landing guide device provided in a floating unit according to a first embodiment, together with main parts thereof;

FIG. 2 is a schematic plan view of a first embodiment;

FIG. 3 is a schematic plan view showing the entire configuration of a kite launching and landing guide device provided in the floating unit according to a second embodiment together with the main parts thereof; and

FIG. 4 is a schematic side view showing a kite launching and landing guide device according to the second embodiment together with a kite and a tether.

### DETAILED DESCRIPTION OF EMBODIMENTS

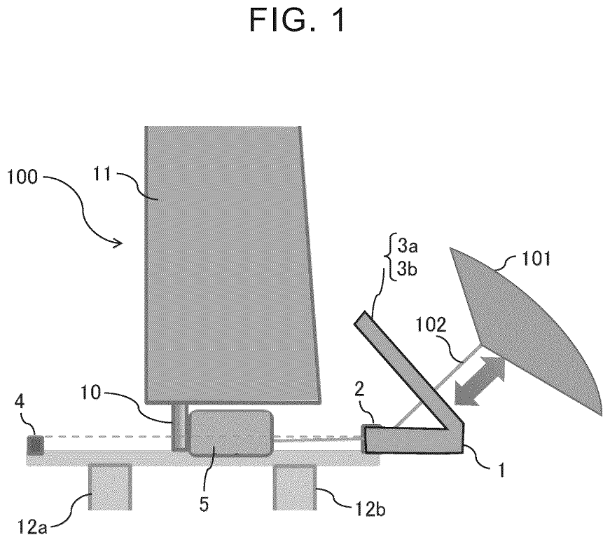

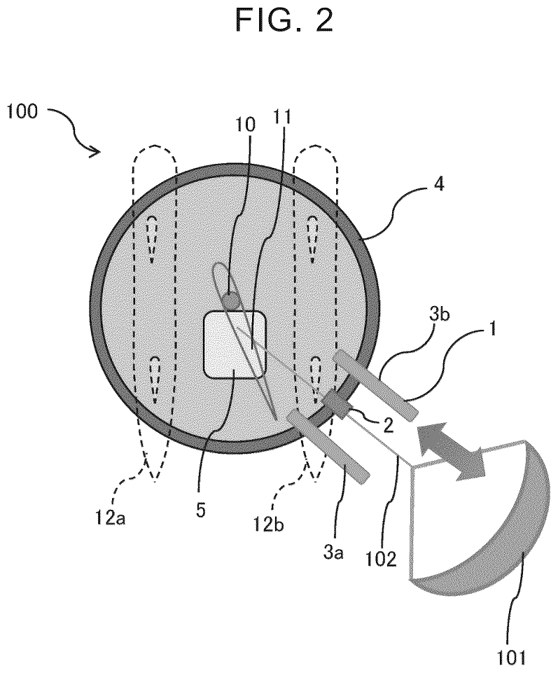

First, a kite launching and landing guide device provided in a floating unit according to the first embodiment will be described with reference to FIGS. 1 and 2. In the present embodiment, a tethered wind power generation system is constructed with a kite unit including a kite fried from a floating unit such as a yacht or an offshore unit.

As shown in FIGS. 1 and 2, the floating unit 100 according to the present embodiment includes the launching and landing guide device 1 for the kite 101, the winch 5, the mast 10 and the sail 11, and the hulls 12a, 12b.

The winch 5 is configured to wind up or unwind the tether 102 having the kite 101 attached to its distal end on its root side via the launching and landing guide device 1. The mast 10 and the sail 11 are configured to enable the floating unit 100 to navigate as a yacht. The hulls 12a, 12b are used to float the floating unit 100 on the water by buoyancy, and may serve as ballasts by adjusting the amount of water stored therein. As described above, the floating unit 100 is constructed as a catamaran ship having excellent navigation performance and stability.

The launching and landing guide device 1 includes a movable pulley 2 constituting an example of a “position setting unit”, a pair of arms 3a, 3b constituting an example of the “launching and landing guide unit”, and a guide rail 4 constituting an example of a “movement guide unit”.

The movable pulley 2 sets the position where the tether 102 is unwound and wound to a position where the tether 102 and the kite 101 do not interfere with the mast 10 and the sail 11 of the floating unit and other parts or structures mounted on the floating unit 100. In this position, the movable pulley 2 is configured such that unwinding and winding of the tether 102 via the movable pulley 2 is performed by the rotational drive of the winch 5.

Each of the pair of arms 3a, 3b has an abutment surface (a surface facing obliquely upward in FIG. 1), and is configured to be able to fix the kite 101 by abutting the kite on the abutment surface by the tension received from the winch 5 via the tether 102 when the tether 102 is wound up in the winch 5 in order to land the kite 101 in an emergency or in a normal state, for example, at the end of wind power generation. On the other hand, the pair of arms 3a, 3b are configured such that the tether 102 passes between the pair of arms 3a, 3b when the tether 102 is unwound or wound via the movable pulley 2, e.g., to take off the kite 101 for starting wind power or to change the length of the tether 102, e.g., for wind power generation.

The guide rail 4 has a circumferential track laid along the outer circumference of the movable area of the sail 11, the movable pulley 2 is movably mounted along the guide rail 4, and the pair of arms 3a, 3b are movably mounted integrally with the movable pulley 2 along the guide rail 4 (see FIG. 2). The pair of arms 3a, 3b and the movable pulley 2 can be smoothly circumferentially moved along the outer periphery of the interference region related to the sail by rolling or sliding along the guide rail 4.

The pair of arms 3a, 3b and the movable pulley 2 are fixed to each other, and are configured to be movable on the guide rail 4 in accordance with the orientation of the kite 101 during the flight of the kite 101. However, the pair of arms 3a, 3b and the movable pulley 2 may be configured to be movable separately without being fixed to each other. Alternatively, the pair of arms 3a, 3b and the movable pulley 2 may be configured to be actively movable on the guide rail 4 by a drive device such as an actuator or a motor depending on the orientation of the kite 101.

The kite 101 may be configured such that the area of the kite 101 is reduced when it is collected or stored in the floating unit 100, so that it is preferable to reduce the air resistance force of the kite 101 during navigation or anchoring of the floating unit 100. For this purpose, for the kite 101, for example, an existing technology such as a foldable type or an inflatable structure may be employed.

Further, when storing the kite 101, it is desirable to lock the kite 101 mechanically or electromagnetically while being tensioned by the tether 102 to prevent the kite 101 from flapping in the wind during navigation or anchoring of the floating unit 100.

Since the first embodiment is configured as described above, when the tether 102 is unwound or wound, the tether 102 is passed between the pair of arms 3a, 3b even if the kite 101 and the tether 102 move around in various directions in the vicinity of the sail 11 in accordance with the flight condition of the kite 101, the wind direction and the wind speed in the sky and the low sky, and the like, and the position where the tether 102 is unwound and wound is set by the movable pulley 2 while the tether 102 is guided. As a result, the kite 101 and the tether 102 do not interfere with the sail 11 or the like of the floating unit 100.

Therefore, even if the tether 102 is wound at a relatively high speed by the winch 5 when the kite 101 is landed, quick landing or emergency landing can be performed while the tether 102 and the kite 101 are not entangled with or collided with the sail 11. Further, after landing or recovery of the kite 101, the kite 101 is fixed in a stable predetermined position on the floating unit 100 by being brought into contact with the contact surfaces of the pair of arms 3a, 3b while the tether 102 is taut. This makes it more convenient for the next launching of the kite 101.

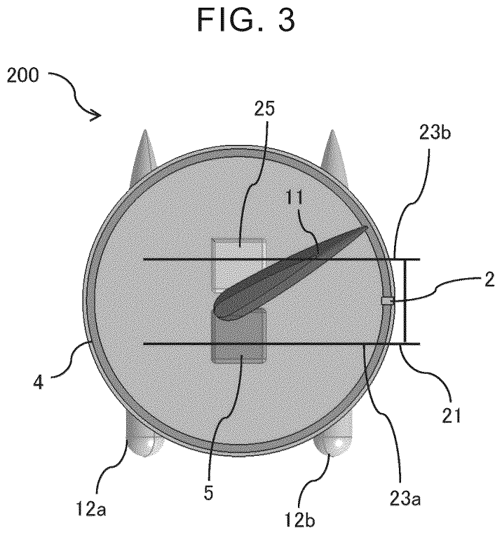

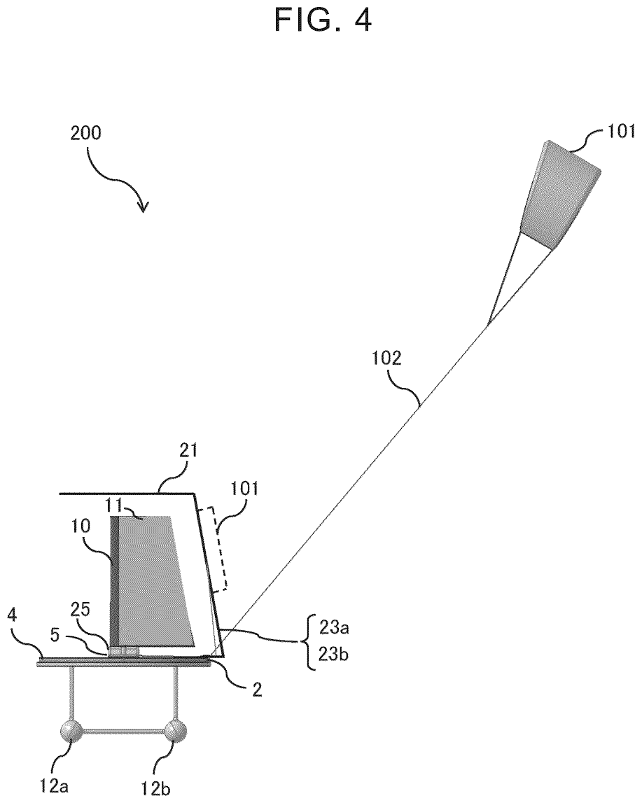

Next, a kite launching and landing guide device provided in a floating unit according to a second embodiment will be described with reference to FIGS. 3 and 4. In the present embodiment, a tethered wind power generation system is constructed in which a floating unit such as a yacht, for example, is combined with a kite unit including a kite fried therefrom. In FIGS. 3 and 4, the same components as those in the first embodiment described with reference to FIGS. 1 and 2 are denoted by the same reference numerals, and the description thereof will be omitted.

As shown in FIGS. 3 and 4, the floating unit 200 according to the present embodiment includes the launching and landing guide device 21 for the kite 101, the winch 5, the mast 10 and the sail 11, the hull 12a and 12b, and the drive device 25.

The launching and landing guide device 21 includes a movable pulley 2, a pair of arms 23a, 23b constituting another exemplary “launching and landing guide unit”, and a guide rail 4.

Each of the pair of arms 23a, 23b has an abutment surface (a surface facing obliquely upward and rightward in FIG. 4), and is configured to be able to fix the kite 101 by abutting the kite on the abutment surface by tension received from the winch 5 via the tether 102 when the tether 102 is wound up in the winch 5 in order to land the kite 101. On the other hand, the pair of arms 23a, 23b are configured such that the tether 102 passes between the pair of arms 23a, 23b when the tether 102/1 is unwound or wound via the movable pulley 2 for taking off the kite 101 or the like.

The launching and landing guide device 1 is preferably configured such that the kite 101 is located at the position of the kite 101 for launching and landing (in other words, in a position or attitude suitable for landing, launching, and both launching and landing) indicated by a broken line in FIG. 4, when the kite 101 lands or before launching. As a result, the function of the launching and landing guide device 1 as a kite launching and landing stand is significantly enhanced.

In the present embodiment, in particular, the pair of arms 23a, 23b are configured to partially surround the side and the upper side of the mast 10 and the sail 11, respectively. That is, the pair of arms 23a, 23b according to the second embodiment has a straight portion in which a straight portion constituting the abutting surface extends longer in an obliquely upward direction (direction obliquely upward from the left in FIG. 4) and extends horizontally above the sail 11 as compared with the pair of arms 3a, 3b according to the first embodiment. With this configuration, the launching and landing guide device 21 can protect the sail 11 from the tether 102, the kite 101, and any flying object that can fly from the side or the upper side.

Furthermore, in the present embodiment, in particular, the launching and landing guide device 21 includes a drive device 25 that constitutes an example of a “drive unit”. The drive device 25 is configured to actively move the movable pulley 2 and the pair of arms 23a, 23b along the guide rail 4 to a desired azimuth or angulation. More specifically, the drive device 25 includes, for example, an electric actuator, an electromagnetic actuator, a mechanical actuator, or a motor.

Since the second embodiment is configured as described in detail above, the launching and landing guide device 21 can prevent the kite 101 and the tether 102 from interfering with the sail 11 and the like, and can also protect the sail 11.

### APPENDICES

With regard to the embodiments described above, the following additional notes are further disclosed.

### Appendix 1

A kite launching and landing guide device according to appendix 1 of the present disclosure is a kite launching and landing guide device arranged on a floating unit having a winch and a sail for unwinding and winding a tether with a kite attached thereto, wherein the position where the tether is unwound and wound is set to a position where the kite do not interfere with at least the sail of the floating unit. A position setting unit is provided, and a contact portion, when the tether is wound by the winch, the tether is brought into contact with the kite at the contact portion by a tension received from the winch via the tether, so that the tether can be fixed, and when the tether is unwound or wound via the position setting unit, the tether passes through a space beside the contact portion or between the contact portions a launching and landing guide unit for guiding the kite and the tether is provided.

According to the kite launching and landing guide device according to Appendix 1, when the tether is unwound or wound, depending on the flight state of the kite, the wind direction in the sky and low sky, the wind speed and the like, in the vicinity of the sail, even if the kite and the tether moves around or the kite is violated in various directions, the tether is passed through the space between or beside the contact portion of the launching and landing guide unit, for example, a pair of arms, and the position where the tether is unwound and wound is set by a position setting unit which is, for example, a “pulley” while the tether is guided. As a result, the kite or tether does not interfere with at least the sail of the floating unit. Furthermore, it may be configured so as not to interfere with parts or structures other than the sail in the floating unit.

Therefore, even if the tether is wound at a relatively high speed by the winch when the kite is landed, quick landing or emergency landing can be performed without the tether or the kite being entangled or collided with the sail, which is extremely advantageous in practical use. Further, after landing or recovery of the kite, the kite is fixed in a stable posture on the floating unit by being brought into contact with the contact portion in a state where the tether is taut. This posture is not only a predetermined posture suitable for landing or fixing, but also a predetermined posture suitable for launching, which is more convenient for the next launching of the kite. As a result, it is possible to prevent a situation in which the kite is shaken by wind or waves on the floating unit during movement or standby, and further, it is possible to smoothly take off and land the kite.

The floating unit provided with the kite launching and landing guide device may constitute a tethered wind power generation system together with the kite unit provided on the kite. In this case, the winch can function not only as a motor generator for unwinding and winding the kite and fixing the kite, but also as a motor generator for wind power generation, which is very advantageous from the viewpoint of reducing the number of parts or simplifying the device configuration.

### Appendix 2

In the kite launching and landing guide device according to Appendix 2 of the present disclosure, the launching and landing guide unit has a pair of arms provided on both sides of the position setting unit as the contact portion, and when the tether is wound up by the pair of arms, the tether is held in a predetermined posture for launching and landing. The kite launching and landing guide device according to Appendix 1, wherein the tether is passed between the pair of arms and guides the kite and the tether when unwinding or winding the tether.

According to the kite launching and landing guide device described in Appendix 2 of the present disclosure, the tether is passed between the pair of arms, and the position where the tether is unwound and wound is set to the position setting unit at a position sandwiched between the pair of arms. Therefore, quick landing or emergency landing can be performed without the tether or kite being entangled with or hitting a part other than the sail or the sail. Further, after landing or recovery of the kite, the kite is stably fixed in a predetermined posture on the floating unit by being brought into contact with the contact surface of the pair of arms in a state in which the tether is taut.

### Appendix 3

The kite launching and landing guide device according to Appendix 3 of the present disclosure is the launching and landing guide device for a kite according to Appendix 1 or 2, further comprising a movement guide unit for movably holding the position setting unit and the launching and landing guide unit along an outer periphery of an interference region where there is a possibility that the sail exists when the sail rotates in a plan view.

According to the kite launching and landing guide device described in Appendix 3 of the present disclosure, the position setting unit and the launching and landing guide unit can be moved or rotated around the outer periphery of the interference region, so that even if the kite is violently rotated around the sail, interference between the tether or the kite and the sail can be prevented more reliably. In this case, in particular, since there is a movement guide unit, the position setting unit and the launching and landing guide unit can be moved or rotated along the outer periphery of the interference region of the sail mainly by the horizontal component of the tension received from the kite via the tether. For example, even when the kite moves in the east, west, south, and north by changing the wind direction, the position setting unit and the launching and landing guide unit are passively movable by the movement guide unit in such a manner as to be pulled by the kite through the tether.

Even without such a movement guide unit, that is, even if the position setting unit and the launching and landing guide unit are fixed to the floating unit, the effect of smoothing launching and landing in the kite launching and landing guide device described in Appendix 1 described above can be exerted accordingly. For example, by changing the orientation of the floating unit itself (for example, the heading of the bow), it is also possible to change the orientation of the position setting unit and the launching and landing guide unit mounted on the floating unit.

### Appendix 4

A kite launching and landing guide device according to Appendix 4 of the present disclosure is the kite launching and landing guide device according to Appendix 3, wherein the movement guide unit has a guide rail having a circulation track laid along the outer periphery, the position setting unit has a movable pulley movably attached along the guide rail, and the launching and landing guide unit is integrally movably attached to the position setting unit along the guide rail.

With this configuration, the movable pulley, which is an example of the position setting unit, can smoothly move around along the outer periphery of the interference region by rolling or sliding on the guide rail constituting an example of the movement guide unit together with the launching and landing guide unit.

It should be noted that the movable pulley may be configured to be able to move around smoothly along the outer periphery of the interference region by movement by a guide arm that performs a rotation operation in a horizontal plane, which constitutes an example of a movement guide unit, instead of the guide rail.

Alternatively, the position setting unit and the launching and landing guide unit may be integrally or integrally formed, and the launching and landing guide unit may be, for example, a pair of frames or frame arms through which a tether is passed, and the position setting unit may be configured to include, instead of a pulley, a rotation surface or a sliding surface provided so that the tether can smoothly pass through an inner surface of the launching and landing guide unit that faces (i.e., comes into contact with or is likely to come into contact with) a side surface of the tether.

### Appendix 5

The kite launching and landing guide device according to Appendix 5 of the present disclosure is the kite launching and landing guide device according to any one of Appendices 1 to 4, wherein the launching and landing guide unit has a shape partially surrounding the sail from the side and the upper side.

According to the kite launching and landing guide device described in Appendix 5 of the present disclosure, the launching and landing guide unit having a function of guiding the launching and landing can partially surround or enclose the sail from the side and the upper side, thereby protecting the sail from the tether or the kite that can fly from the side and the upper side, and also from any flying object.

### Appendix 6

The kite launching and landing guide device according to Appendix 6 of the present disclosure is the kite launching and landing guide device according to Appendix 3 or 4, further includes a driving unit for actively moving the position setting unit and the launching and landing guide unit along the guide rail.

With this configuration, even if the kite moves in the east, west, south, and north directions in the sky due to the wind direction change, the position setting unit and the launching and landing guide unit are actively movable along the guide rail to a desired azimuth. In this case as well, the movable pulley and the launching and landing guide unit may be configured to be able to move around by the movement of the guide arm constituting an example of the movement guide unit instead of the guide rail.

### Appendix 7

The floating unit according to Appendix 7 of the present disclosure includes the launching and landing guide device according to any one of Appendices 1 to 6.

According to the floating unit described in Appendix 7 of the present disclosure, when the kite is landed by the launching and landing guide device described in any one of Appendices 1 to 6 described above, it is possible to perform quick landing or emergency landing while the tether or the kite is not entangled or collided with the sail, thereby enabling smooth launching and landing of the kite.

The present disclosure can be modified as appropriate within the scope and spirit of the disclosure which can be read from the claims and the specification as a whole, and a kite launching and landing guide device with such a modification or a floating unit including the same is also included in the technical idea of the present disclosure.

What is claimed is:

1. A kite launching and landing guide device that is disposed in a floating unit including a winch and a sail, the winch being configured to unwind and wind a tether with a kite attached to the tether, the kite launching and landing guide device comprising:
a position setting unit configured to set a position where the tether is unwound and wound to a position where the tether and the kite do not interfere with at least the sail of the floating unit; and
a launching and landing guide unit including a contact portion, the launching and landing guide unit being configured to, when the tether is wound by the winch, fix the kite by contacting the kite at the contact portion by a tension received from the winch via the tether, and being configured to, when the tether is unwound or wound via the position setting unit, guide the kite and the tether in such a manner that the tether passes through a space beside the contact portion or between the contact portions.

2. The kite launching and landing guide device according to claim 1, wherein:
the launching and landing guide unit includes, as the contact portion, a pair of arms provided at both sides of the position setting unit; and
the launching and landing guide unit is configured to
when the tether is wound, hold the kite in a predetermined attitude for launching and landing by contacting the kite at the arms, and
when the tether is unwound or wound, guide the kite and the tether by causing the tether to pass between the arms.

3. The kite launching and landing guide device according to claim 1, further comprising a movement guide unit configured to hold the position setting unit and the launching and landing guide unit in such a manner that the position setting unit and the launching and landing guide unit are movable along an outer periphery of an interference region, the interference region being a region where there is a possibility that the sail is present when the sail is rotated, as viewed in plan.

4. The kite launching and landing guide device according to claim 3, wherein:
the movement guide unit includes a guide rail having an orbital track laid along the outer periphery;
the position setting unit includes a movable pulley mounted so as to be movable along the guide rail; and
the launching and landing guide unit is mounted so as to be movable with the position setting unit along the guide rail.

5. The kite launching and landing guide device according to claim 1, wherein the launching and landing guide unit has such a shape that the launching and landing guide unit partially surrounds the sail from a side and above.
